(19) United States
(12) Patent Application Publication
(10) Pub. No.: US 2020/0263588 A1
(43) Pub. Date: Aug. 20, 2020

(54) CATALYST SUBSTRATE AND FILTER STRUCTURE INCLUDING PLATES AND METHOD OF FORMING SAME

(71) Applicant: Cummins Emission Solutions Inc., Columbus, IN (US)

(72) Inventors: Taren DeHart, Columbus, IN (US); Randolph G. Zoran, McFarland, WI (US); Ryan M. Johnson, Cottage Grove, WI (US); Stephen M. Holl, Columbus, IN (US); John G. Buechler, Indianapolis, IN (US); Matthew L. Anderson, Columbus, IN (US)

(21) Appl. No.: 16/060,604

(22) PCT Filed: Oct. 20, 2017
(86) PCT No.: PCT/US2017/057648

§ 371 Date: Jun. 8, 2018

Related U.S. Application Data
(60) Provisional application No. 62/411,274, filed on Oct. 21, 2016.
(60) Provisional application No. 62/411,332, filed on Oct. 21, 2016.

(51) Int. Cl. F01N 3/28; B01D 53/94

(52) U.S. Cl. CPC F01N 3/2839; F01N 2510/068; F01N 2450/22; B01D 53/9431

(57) ABSTRACT

Methods of combining catalytic plates into an assembly of a non-monolithic structure, such as a catalyst substrate or filter assembly, of an exhaust aftertreatment system. A plurality of plates may be disposed within a housing in an arrangement that may define a catalytically active volume of a substrate. Each of the plurality of plates may be single-curved or multiple-curved and/or may be represented by three-dimensional nestable structures. The arrangement of plates may be configured such that the flow is axial, radial, or represented by a hybrid, multi-segment intake path. The plurality of plates may be arranged such that they are configured to receive targeted amounts of coating agent, which may differ among the plates.

### CROSS REFERENCE TO RELATED APPLICATIONS

The present application claims the benefit of priority to U.S. Provisional Application No. 62/411,332, filed Oct. 21, 2016 and U.S. Provisional Application No. 62/411,274, filed Oct. 21, 2016. The contents of both applications are incorporated herein by reference in their entirety.

### TECHNICAL FIELD

The present application relates generally to the field of aftertreatment systems for internal combustion engines.

### BACKGROUND

For internal combustion engines, such as diesel engines, nitrogen oxide (NOₓ) compounds may be emitted in the exhaust. To reduce NOₓ emissions, a selective catalytic reduction (SCR) process may be implemented to convert the NOₓ compounds into more neutral compounds, such as diatomic nitrogen, water, or carbon dioxide, with the aid of a catalyst and a reductant. The catalyst may be included in a catalyst chamber of an exhaust system, such as that of a vehicle or power generation unit. A reductant, such as anhydrous ammonia, aqueous ammonia, or urea may be typically introduced into the exhaust gas flow prior to the catalyst chamber. To introduce the reductant into the exhaust gas flow for the SCR process, an SCR system may dose or otherwise introduce the reductant through a dosing module that vaporizes or sprays the reductant into an exhaust pipe of the exhaust system up-stream of the catalyst chamber. The SCR system may include one or more sensors to monitor conditions within the exhaust system.

### SUMMARY

Implementations described herein relate to catalyst substrates or filters comprised of plates of various shapes.

One implementation relates to an assembly and the related methods and apparatus, where the assembly includes a housing and a non-monolithic substrate of a catalyst. Several plates are provided and disposed within the housing and define a catalytically active volume of the non-monolithic substrate. In addition, each of the plates may be combined together in an arrangement of plates to form the non-monolithic substrate, and the arrangement of plates may be flexibly configured to define an intake path. The plates may be combined so as to define an inlet area. Each of the plurality of plates may comprise a first end and a second end, and the assembly may comprise a plurality of plugs. The first end of the first plate may be affixed to the second end of the second plate via a plug in the plurality of plugs.

Each of the plurality of plates may include single-curved or multiple-curved plates. Each of the plurality of plates may conform to a specified three-dimensional structure to enable each of the plurality of plates to nest together.

In another implementation, the arrangement may be configured so that the intake direction of the intake flow may be multi-axial such that the specified intake direction along a first segment is different from the specified intake direction along a second segment.

In another implementation, the assembly may be configured such that the plurality of plates may comprise a first plate and a second plate arranged such that the first plate may be configured to receive a first targeted amount of a catalyst coating agent and the second plate may be configured to receive a second targeted amount of the catalyst coating agent. The first targeted amount of the catalyst coating agent may be different from the second targeted amount of the catalyst coating agent. The first targeted amount of the catalyst coating agent may be applied to the first plate of the plurality of plates, and the second targeted amount of the catalyst coating agent may be applied to the second plate of the plurality of plates.

Another implementation includes a process for combining plates into an assembly representing a non-monolithic structure of an exhaust aftertreatment system, where the plates may be positioned in a flow-through arrangement. The process may include providing a plurality of plates, aligning the plurality of plates, operatively coupling the plurality of plates into an arrangement of plates to form the non-monolithic structure, and disposing the arrangement of plates within a housing. The process may include affixing a bonding agent on a first edge of a first plate of the plurality of plates, affixing the bonding agent on a second edge of a second plate of the plurality of plates, and, during the operatively coupling of the plurality of plates, bonding the first plate to the second plate by placing the first edge of the first plate against the second edge of the second plate. The first plate may have a corrugated surface and the second plate may have a flat surface. In other example implementations, where plates may be made of metal, as part of operatively coupling the plurality of plates, the first edge of the first plate may be welded to the second edge of the second plate. As part of operatively coupling the plurality of plates, one may crystalline bond the first edge of the first plate to the second edge of the second plate and/or combine each of the plurality of plates together in an arrangement of plates to form a specified non-monolithic three-dimensional structure via 3D printing.

In order to physically bond two different plates made of similar materials, a firing process, such as one used in Cordierite or other crystalline structures, may be used. Also, one may effectuate crystal growth through the use of the mullitization process. In some instances, green or prepared plates may be compacted together and then fired, sintered, or mullitized, thereby creating a strong bond between the different structures so that, when bonded in such a manner the entirety, they act as a monolith.

The plates may be constructed in such a manner that the heights for walls forming the channels in the substrate or filter where the bonding is to happen are of similar height and/or frequency in the case of a sinusoidal channel. Such an arrangement provides uniform bonding down the entirety of the length of the walls of the channel.

Another implementation, which allows for improved thermal expansion properties, involves having differential heights along the walls of the channel to allow for gaps or spaces in the bonding. These gaps may be aligned so as to allow for the thermal expansion of the substrate following the higher differential in heat flux of the material and air flow, thus limiting the risk of too aggressive thermal growth.

Another implementation relates to an assembly and the related methods and apparatus, where the assembly includes a housing and a non-monolithic substrate of a catalyst. Several plates are disposed within the housing and define a catalytically active volume of the non-monolithic substrate.

The assembly further comprises a catalytically active volume defined by the plurality of separate plates, which may be flexibly configured in an expandable arrangement. In addition, each of the plurality of separate plates may be combined together in an arrangement of separate plates to form the non-monolithic substrate, and the arrangement of separate plates may be flexibly configured to define an intake path. The plates may be capable of being combined so as to define an inlet area. Each of the plurality of separate plates may include single-curved, or multiple-curved, v-shaped or s-shaped plates.

In another implementation, the arrangement may also be configured so that the intake direction of the intake flow may be multi-axial such that the specified intake direction along the first segment may be different from the specified intake direction along the second segment.

In yet another implementation, the assembly may be configured such that the plurality of separate plates may comprise a first separate plate and a second separate plate arranged such that the first separate plate may be configured to receive a first targeted amount of a catalyst coating agent and the second separate plate may be configured to receive a second targeted amount of the catalyst coating agent. The first targeted amount of the catalyst coating agent may be different from the second targeted amount of the catalyst coating agent.

### BRIEF DESCRIPTION

The details of one or more implementations are set forth in the accompanying drawings and the description below. Other features, aspects, and advantages of the disclosure will become apparent from the description, the drawings, and the claims, in which:

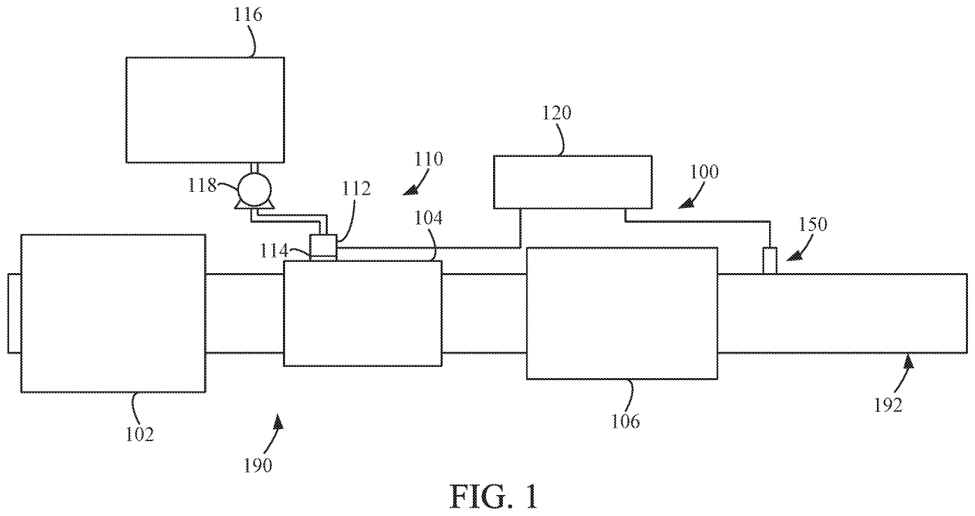

FIG. 1 is a block schematic diagram of an example aftertreatment system comprising an example reductant delivery system for an exhaust system;

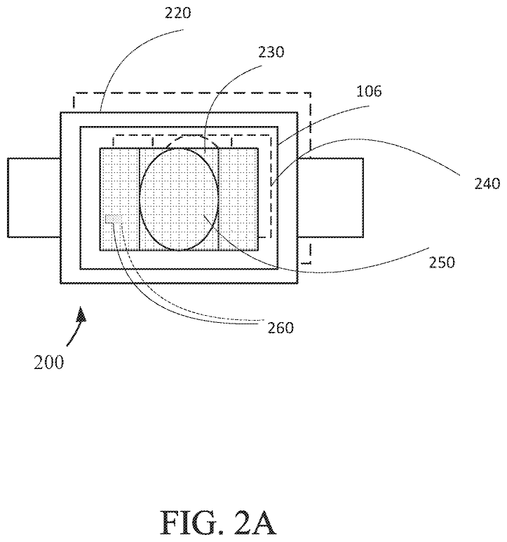

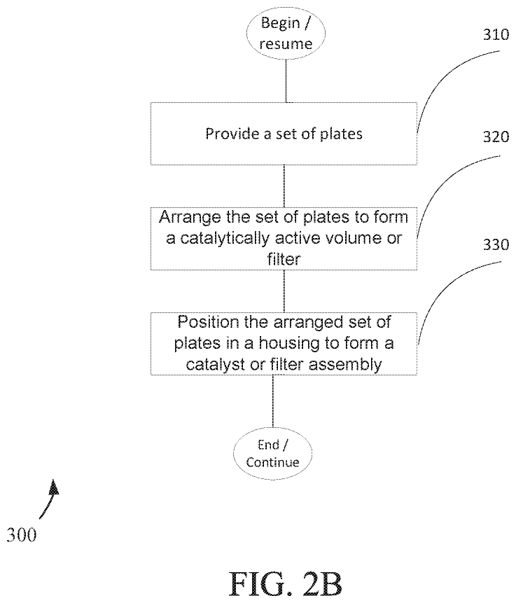

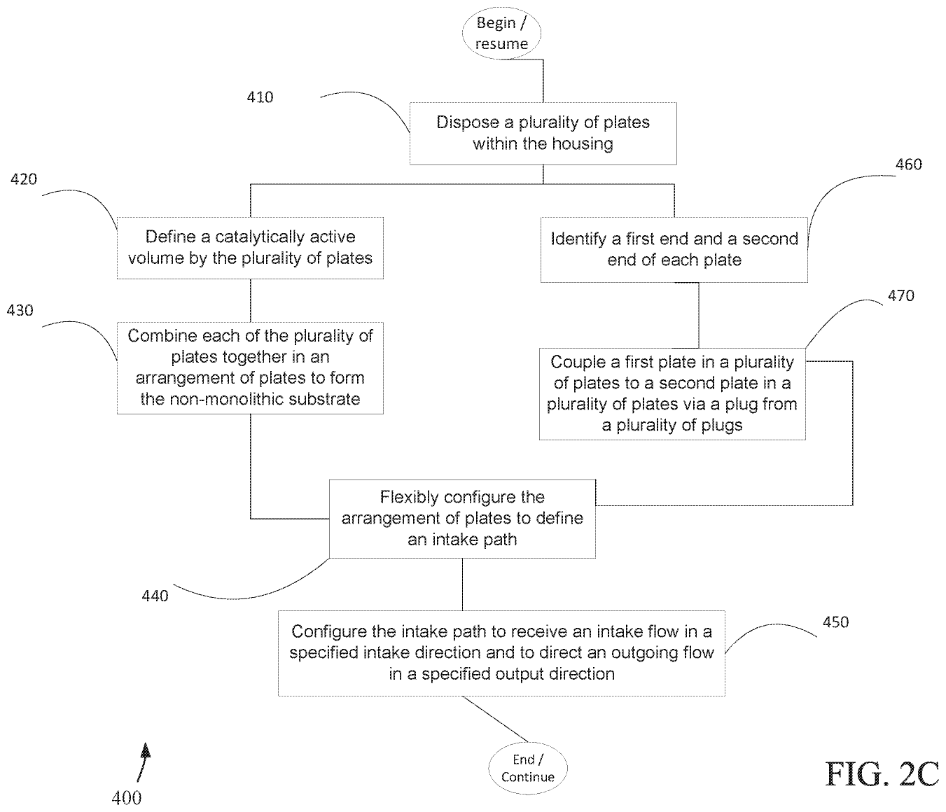

FIG. 2A is a schematic, cross-sectional view of an example catalyst comprising an example catalyst housing, a substrate, a SCR catalyst, a catalytically active volume, and an inlet area;

FIG. 2B is an example process diagram, according to a particular embodiment, for constructing a catalyst or filter assembly;

FIG. 2C is another example process diagram, according to a particular embodiment, for combining plates into a catalyst or filter assembly;

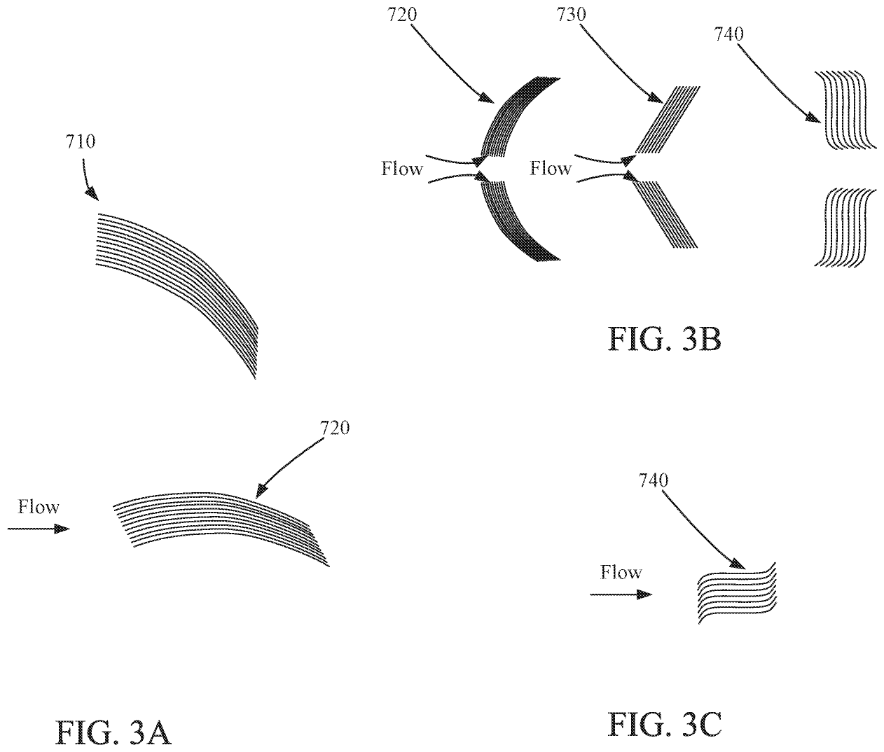

FIG. 3A is a magnified schematic, cross-sectional view of an example implementation, showing an example curved member or plate for a curved substrate;

FIG. 3B is a magnified schematic view of example implementations where the plates are in a flow-through arrangement, depicting an example configurations of curved members, v-shaped members, and s-shaped members;

FIG. 3C is a magnified schematic view of an example implementation where s-shaped plates are stacked;

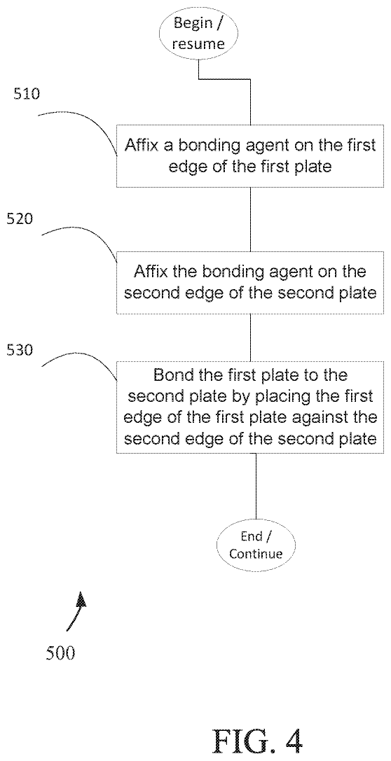

FIG. 4 depicts an example process, according to a particular embodiment, for arranging an assembly such that the plates are in a flow-through arrangement;

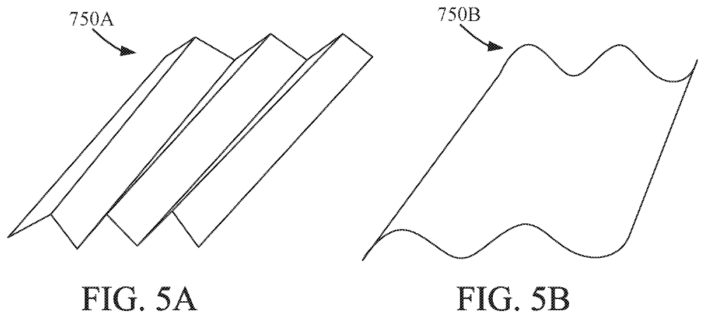

FIG. 5A depicts a magnified perspective view of an example implementation, showing a configuration of multiple v-shaped member or plate;

FIG. 5B depicts a magnified perspective view of an example implementation, showing a configuration of multiple-curved member or plate;

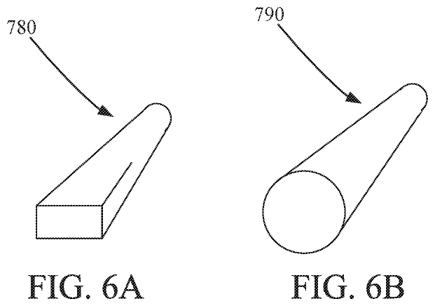

FIG. 6A depicts a magnified schematic view of another example implementation, depicting non-uniform members that nest together to form an example non-uniform substrate;

FIG. 6B depicts a magnified schematic view of another example implementation, depicting a circular that nest together to form an example conical substrate; and

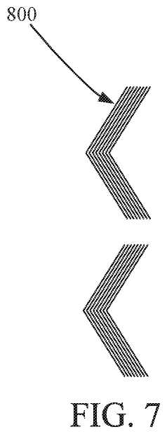

FIG. 7 is a magnified schematic view of another example implementation, depicting a member of an example substrate, wherein the member of the example substrate is v-shaped.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, assemblies, and systems for combining catalytic plates of various shapes into an assembly. The various concepts introduced above and discussed in greater detail below may be implemented in any of numerous ways, as the described concepts are not limited to any particular manner of implementation. Examples of specific implementations and applications are provided primarily for illustrative purposes.

### 1. Overview

Methods, apparatus, assemblies and/or systems may be desired to improve certain performance characteristics of an aftertreatment system, including, for example, flow distribution, uniformity, catalytic performance, particle number, and/or ash performance. These characteristics may be controlled by, for example, utilizing extendable catalyst substrates or filters that are composed of catalytic plates and/or configuring the plates to improve certain performance characteristics by, for example, controlling shapes and/or contours of the plates. A catalyst or filter assembly may be composed of individual loose plates that are then combined into the assembly via certain procedures.

The individual plates could be of a variety of shapes, including, by way of non-limiting example, straight, curved, domed, conical, and/or s-shaped. The shape of the plates may be such that the plates may impact the performance of the catalyst across such metrics as, for example, NOₓ, HC, ammonia, ash, and/or particle number (PN) performance.

In a catalyst or filter assembly that is composed of members, such as plates, rather than a traditional monolith substrate, the members may be arranged to form a structure where the flow may be axial, radial or a hybrid combination of a multi-axis flow (e.g., with axial and radial components). In axial flow catalyst arrangements, the inlet area may be dictated by catalyst diameter, and the backpressure may increase as the length and volume of the catalyst increase. To achieve improvements in flow uniformity and backpressure, a catalyst assembly may be desired that comprises separate members combined together to form the substrate. In some instances, the members may be arranged such that the structure is aligned with incoming flow. In addition, a structure that has a radial flow arrangement may be desired to allow the flexibility of adding inlet area through the addition of length through additional members, such as stacking plates. A structure that has a linear or axial flow arrangement may also be desired to improve the capability to achieve a target backpressure or conversion rate with a change in volume through a length increase or decrease by adding or removing members from the stack. This may be accomplished, for example, by configuring the catalyst or filter assembly such that a desired number of members, such as plates, are added or removed. The individual plates could be of a variety of shapes, including, by way of non-limiting example, straight, curved, domed, conical, and/or s-shaped. Furthermore, an implementation may be desired where the example catalyst assembly is configured to direct outgoing flow in a direction that is desired.

As to other considerations, such as space and cost, flow control aftertreatment system devices, such as perforation plates, mixers, etc., used to enable good flow uniformity, may be eliminated and replaced in design and operation by configuring the separate members, such as plates, into an arrangement to control the flow uniformity. The shape of the plates may be such that the plates impact the performance of the catalyst across such metrics as, for example, NOₓ, HC, ammonia, ash, and/or particle number performance. In some instances, the plates may be substantially flat or the plates may have a two-dimensional or three-dimensional geometry.

As to substrate coating, most coating procedures developed to coat a radial monolith may not be preferable due to a lack of uniformity and lack of ability to dispose multiple coatings on the same substrate. In particular, this may affect SCR and ammonia oxidation (AMOX) catalysts where the reactions are sensitive to PT contamination. As an example, monolith coating strategies can include a waterfall procedure using a rotating substrate to pour the catalyst material on the exterior and into the channels of the substrate as the substrate is rotated, a vacuum draw procedure that applies a vacuum to an exterior surface of the substrate to draw the catalyst material from a center column out to the edges, or a water wheel style of application where a rotating substrate dips into and out of a pool of catalyst material. In the foregoing procedures, the catalyst material may not be adequately coated on the surfaces of the substrate and/or may be unevenly applied. On the other hand, by utilizing several plates to assemble the catalyst substrate, precision coating options may be utilized on each plate prior to assembly to ensure adequate or targeted catalyst material application and/or uniform application. Such precision coating procedures may include silk screening catalyst material onto a plate, plotting (for example, using an application pen or a small hydraulic spray gun) catalyst material onto a plate, and/or printing (i.e., targeted deposition) catalyst material onto a plate.

Arrangements and methods may be desired where separate members, such as plates, allow catalyst coating to be applied, with precision, to a member where the catalyst coating can best be utilized. For instance, application of the catalyst coating can be minimized if a member or a portion thereof is in a location of reduced value, such as a low flow region within the catalyst. Accordingly, each member comprising the catalyst may be optimized for a desired level of performance. Further, the individual plates could be precision-coated with the desired catalyst formulation, such as, by way of non-limiting example, a washcoat and/or a precious metal.

Arrangements and methods described herein may result in cost savings because, inter alia, the catalyst coating could be precisely placed on the plates where needed. In addition, a method may precisely apply the catalyst to a structure in a controlled way. Furthermore, a method may also apply multiple layers. Further still, a method may be one where the coating density could be varied and coverage could be modified in one or more of the following manners: across the catalyst or filter assembly to match air flow direction, across the plate to enable additional functionality, or across a channel in a region conducive to maximizing gas flow, such as along the outside bend of a curved channel. An additional effect may be desired that would allow for differentiating the product further down the supply chain to streamline the infrastructure and reduce inventory. In some instances, areas may be identified within the catalyst or filter assembly that will be prepared to be cemented or bonded later and therefore should not be coated.

In addition, a catalyst structure that has a radial flow arrangement may be desired to allow the flexibility of adding inlet area through the addition of catalyst length through additional members, such as stacking plates. A catalyst structure that has a linear or axial flow arrangement may be desired to improve the capability to achieve a target backpressure or conversion rate with a change in catalyst volume through a length increase or decrease from adding or removing members from the horizontal stack. This may be accomplished, for example, by configuring the assembly such that a desired number of members, such as plates, is added or removed.

### 2. Overview of Aftertreatment System

FIG. 1 depicts an aftertreatment system 100 having an example reductant delivery system 110 for an exhaust system 190. The aftertreatment system 100 includes a filter 102 (such as a diesel particulate filter (DPF)), the reductant delivery system 110, a decomposition chamber 104 or reactor pipe, a SCR catalyst 106, and a sensor 150.

The particulate filter 102 is configured to remove particulate matter, such as soot, from exhaust gas flowing in the exhaust system 190. The particulate filter 102 includes an inlet, where the exhaust gas is received, and an outlet, where the exhaust gas exits after having particulate matter substantially filtered from the exhaust gas and/or converting the particulate matter into carbon dioxide.

The decomposition chamber 104 is configured to convert a reductant, such as urea or diesel exhaust fluid (DEF), into ammonia. The decomposition chamber 104 includes a reductant delivery system 110 having a dosing module 112 configured to dose the reductant into the decomposition chamber 104. In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the particulate filter 102 to receive the exhaust gas containing NOₓ emissions and an outlet for the exhaust gas, NOₓ emissions, ammonia, and/or remaining reductant to flow to the SCR catalyst 106.

The decomposition chamber 104 includes the dosing module 112 mounted to the decomposition chamber 104 such that the dosing module 112 may dose the reductant into the exhaust gases flowing in the exhaust system 190. The dosing module 112 may include an insulator 114 interposed between a portion of the dosing module 112 and the portion of the decomposition chamber 104 to which the dosing module 112 is mounted. The dosing module 112 is fluidly coupled to one or more reductant sources 116. In some implementations, a pump 118 may be used to pressurize the reductant from the reductant source 116 for delivery to the dosing module 112.

The dosing module 112 and pump 118 are also electrically or communicatively coupled to a controller 120. The controller 120 is configured to control the dosing module 112 to dose reductant into the decomposition chamber 104. The controller 120 may also be configured to control the pump 118. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 106 includes inlet in fluid communication with the decomposition chamber 104 from which exhaust gas and reductant is received and an outlet in fluid communication with an end of the exhaust system 190.

The exhaust system 190 may further include a diesel oxidation catalyst (DOC) in fluid communication with the exhaust system 190 (e.g., downstream of the SCR catalyst 106 or upstream of the particulate filter 102) to oxidize hydrocarbons and carbon monoxide in the exhaust gas.

In some implementations, the particulate filter 102 may be positioned downstream of the decomposition chamber 104 or reactor pipe. For instance, the particulate filter 102 and the SCR catalyst 106 may be combined into a single unit, such as an SDPF. In some implementations, the dosing module 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190, such as a tip of the sensor 150 may extend into a portion of the exhaust system 190. In other implementations, the sensor 150 may receive exhaust gas through another conduit, such as a sample pipe extending from the exhaust system 190. While the sensor 150 is depicted as positioned downstream of the SCR catalyst 106, it should be understood that the sensor 150 may be positioned at any other position of the exhaust system 190, including upstream of the particulate filter 102, within the particulate filter 102, between the particulate filter 102 and the decomposition chamber 104, within the decomposition chamber 104, between the decomposition chamber 104 and the SCR catalyst 106, within the SCR catalyst 106, or downstream of the SCR catalyst 106. In addition, two or more sensor 150 may be utilized for detecting a condition of the exhaust gas, such as two, three, four, five, or size sensor 150 with each sensor 150 located at one of the foregoing positions of the exhaust system 190.

### 3. Implementations of Methods of Combining Plates into a Catalyst or Filter Assembly

FIG. 2a depicts an example SCR catalyst 200 that includes a housing 220 and a substrate 230 having a catalytically active volume 240 and an inlet area 250. In some implementations, certain characteristics, such as the number of substrate assemblies or substrate positioning, may vary. By way of non-limiting example, an aftertreatment system for the SCR catalyst 200 may also include components such as the particulate filter 102. The housing 220 may include multiple chambers, wherein different types of chemical reactions (for example, reduction, catalysis) may be performed. Furthermore, the SCR catalyst 200 may include multiple assemblies, and such assemblies may include the substrate 230 and/or the housing 220. The housing 220 may house the particulate filter 102, which may be composed of separate plates and define an inlet area. The plates may be connected via plugs.

The substrate 230 may include multiple members, such as plates 260, which may be coupled to other plates 260. The plates 260 are combined in an extendable arrangement to form the substrate 230 in a non-monolithic fashion. Thus, the plates 260 may form a single segment or multiple segments, such as a first segment and a second segment. Furthermore, the plates 260 may be arranged to receive a targeted amount of a catalyst coating agent in regions where maximizing utilization is desired. The first targeted amount may differ from the second targeted amount depending on the location of the region, desirability of application, and/or other factors. Further still, the plates 260 may be flexibly arranged to define a desired catalytically active volume 240 and/or inlet area 250.

FIG. 2b depicts example process, according to a particular embodiment, to form a catalyst or filter assembly. At 310, a set of plates is provided. The set of plates may be single-curved or multiple-curved, corrugated or substantially flat. At 320, the set of plates is arranged to form a catalytically active volume or a filter. At 330, the arranged set of plates is positioned in a housing to form a catalyst or filter assembly. The arrangement can be fixed within the housing or the housing can be formed about the arrangement. One or more plates can be removed from the set of plates to decrease the volume and/or inlet area. One or more plates can be added to the set of plates to increase the volume and/or inlet area.

FIG. 2c depicts a process (400) of combining plates into a catalyst or filter assembly. In one implementation, the assembly includes a non-monolithic substrate of a catalyst which may further include a housing. The process comprises disposing a plurality of plates within the housing (410), defining a catalytically active volume by the plurality of plates (420), arranging the plates by operatively coupling each of the plurality of plates to at least one other plate in the plurality of plates in an arrangement of plates to form the non-monolithic substrate (430), flexibly configuring the arrangement of plates to define an intake path (440), and configuring the intake path to receive an intake flow in a specified intake direction and to direct an outgoing flow in a specified output direction such that the assembly is aligned with the intake flow (450). The intake path may have a first segment and a second segment. The plurality of plates in the assembly may comprise a first plate having a first edge and a second plate having a second ridge. The process may also comprise expandably configuring the arrangement of plates in the assembly to define an inlet area. The plates may overlap. Each plate in the plurality of plates may be an extruded corrugated ribbon with a curved profile, which corkscrews around a center. The plates may be compressed together and bound using any process for binding the plates together described herein.

Further, the specified intake direction of the intake flow in the assembly may be axial, radial, or multi-axial such that the specified intake direction along the first segment is different from the specified intake direction along the second segment. The first plate and the second plate may be arranged such that the first plate is configured to receive a first targeted amount of a catalyst coating agent and the second plate is configured to receive a second targeted amount of the catalyst coating agent, and the first targeted amount of the catalyst coating agent may be different from the second targeted amount of the catalyst coating agent.

In another implementation, such as a filter arrangement, it may be possible to identify a first end and a second end for each plate in the plurality of plates (460), and the assembly may comprise a plurality of plugs (470). The implementation may include the arranging (470) the first plate and the second plate such that the first end of the first plate is coupled to the second end of the second plate via a plug selected from the plurality of plugs. Binding of this nature may allow for thermal expansion of the plates while maintaining the trapping function. Filtration may be accomplished via air movement from one plate to the next rather than from one channel to an adjacent channel.

FIG. 3a depicts a schematic, cross-sectional view of an example implementation, depicting an example curved member or plate 710 for a curved substrate. Multiples of the curved member or plate 710 may be combined, in a housing 220 (shown in FIG. 2) to form a curved structure. The shape of the plate is defined at least in part by the contour 720.

FIG. 3b depicts a schematic view of example implementations where the plates are in a flow-through arrangement. The plates may have a variety of suitable geometric shapes, including, for example, domed, conical, or s-shaped. The shape of the plate is defined at least in part by a contour of the plate, such as contour 720, 730, or 740.

FIG. 3c depicts a schematic view of an example implementation where s-shaped plates are stacked, as in a filter arrangement described in FIG. 2c. The shape of each plate is defined at least in part by the contour 740. For example, to form a multiple curved s-shape, at least two curved, 3D segments may be oriented in space such that their sides are coupled in such a manner that there is no perceptible seam or edge. Thus, the curved 3D segments may be arranged such that they form, at a cross-section, multiple alternating waves. In another example implementation, multiples of the multiple-curved member or plate may be stacked.

FIG. 4 depicts a schematic view of a process 500, according to a particular embodiment, for configuring an assembly where two or more plates are in a flow-through arrangement. The process comprises affixing a bonding agent on the first edge of the first plate (510), affixing the bonding agent on the second edge of the second plate (520), and bonding the first plate to the second plate by placing the first edge of the first plate against the second edge of the second plate (530).

In some instances, the first plate may be corrugated, and the second plate may be flat. The first edge of the first plate may be welded to the second edge of the second plate. In other instances, a crystalline bond bonds the first edge of the first plate to the second edge of the second plate and/or combine each of the plurality of plates together in an arrangement of plates to form the non-monolithic substrate via 3D printing.

FIG. 5A depicts a magnified schematic view of another example implementation, depicting an example configuration of a multiple v-shaped member or plate 750A of a structure, such as the substrate 230 or the particulate filter 102, in a housing 220 (shown in FIG. 2). Multiples of the multiple v-shaped member or plate 750A may be combined to form the multiple v-shaped structure.

Multiples members or plates may be combined to form the v-shaped substrate. For example, to form such a structure, at least two planar, substantially flat, 3D segments may be oriented in space such that their sides are coupled, forming an edge. Thus, the planar 3D segments may be arranged such that they form, at a cross-section, a non-zero angle at a given point of the edge. When similar multiple segments are combined, the arrangement, at its cross-section, may form a w-shape of the multiple v-shaped member or plate 750A of FIG. 5A. In another example implementation, the sides of the 3D segments may be slightly curved at the vertex of the non-zero angle while still presenting an overall v-shape.

FIG. 5B depicts a magnified schematic view of another example implementation, depicting an example configuration of a multiple-curved member or plate 750B of a structure, such as the substrate 230 or the particulate filter 102, in a housing 220 (shown in FIG. 2). Multiples of the multiple-curved member or plate 750B may be combined to form the multiple-curved structure.

Multiples of the multiplecurved members or plates may be combined to form the s-shaped substrate. For example, to form a multiple curved s-shape, at least two curved, 3D segments may be oriented in space such that their sides are coupled in such a manner that there is no perceptible seam or edge. Thus, the curved 3D segments may be arranged such that they form, at a cross-section, multiple alternating waves. In another example implementation, multiples of the multiple-curved member or plate may be stacked.

FIG. 6A depicts a magnified schematic view of another example implementation, depicting a non-uniform cross-sectional substrate 780 formed by differing geometric members or plates. In the implementation shown, an initially square substrate can be combined with varying shaped plates to transform, over a length, to a circular cross-sectional geometry. The members or plates nest together to form an example substrate having the non-uniform structure.

In a combination of non-uniform plates that nest together and make up a substrate assembly, multiple entries or exits from a system can be defined in order to achieve complex flow management. For example, an arrangement of separate members may be configured to define an intake path. The intake path may be further configured to receive an intake flow in a specified intake direction and to direct an outgoing flow in a specified output direction such that a catalyst is aligned with the intake flow. This can be accomplished by, for example, arranging the members such that different segments are defined within the flow path where the intake direction of intake flow is multi-axial such that the intake direction along the first segment is different from the intake direction along the second segment. The individual plates may be stacked/nested together into the desired dimensions and then retained by, for example, mechanical means by affixing them on the sides so that there is no airflow. Such coupling of plates may be accomplished with mat and sheet metal components, such as those used in monolith substrates.

FIG. 6B depicts a magnified schematic view of another example implementation, depicting a conical substrate 790 formed by reducing cross-sectional circular members or plates. In the implementation shown, an initial diameter for the substrate can be set with a first member or plate. The initial diameter can be reduced or expanded when combined with varying sized circular members or plates to transform, over a length, to a second diameter circular cross-sectional geometry. The members or plates nest together to form an example substrate having the conical structure.

FIG. 7 depicts a magnified schematic view of another example implementation, depicting a member or plate 800 of the substrate 230, wherein the member of the example substrate 230 is v-shaped, in the catalyst housing 220 (shown in FIG. 2). The shape of the v-shaped member is defined at least in part by the contour. Multiples of the v-shaped member or plate may be combined to form the v-shaped substrate.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, the separation of various system components in the implementations described above should not be understood as requiring such separation in all implementations, and it should be understood that the described components and systems can generally be integrated in a single product or packaged into multiple products embodied on tangible media.

The term “controller” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as distributed computing and grid computing infrastructures.

As utilized herein, the terms “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims. Additionally, it is noted that limitations in the claims should not be interpreted as constituting “means plus function” limitations under the United States patent laws in the event that the term “means” is not used therein.

The term “coupled” and the like as used herein means the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

The terms “fluidly coupled,” “in fluid communication,” and the like as used herein mean the two components or objects have a pathway formed between the two components or objects in which a fluid, such as water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various exemplary implementations is illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of combining plates into an assembly for an exhaust aftertreatment system, the method comprising:
providing a plurality of plates, wherein a contour of each of the plurality of plates is the same;
aligning the plurality of plates;
operatively coupling the plurality of plates into an arrangement of plates to form a non-monolithic structure; and
disposing the non-monolithic structure within a housing to form the assembly.

2. The method of claim 1, further comprising configuring the arrangement of plates to define an inlet area.

3. The method of claim 1, wherein the step of operatively coupling the plurality of plates into an arrangement of plates comprises:
applying a first targeted amount of a catalyst coating agent to a first plate of the plurality of plates; and
applying a second targeted amount of the catalyst coating agent to a second plate of the plurality of plates;
wherein the first targeted amount is different than the second targeted amount.

4. The method of claim 1, further comprising:
affixing a bonding agent on a first edge of a first plate of the plurality of plates;
affixing the bonding agent on a second edge of a second plate of the plurality of plates; and
during the operatively coupling of the plurality of plates, bonding the first plate to the second plate by placing the first edge of the first plate against the second edge of the second plate.

5. (canceled)

6. The method of claim 1,
wherein the plurality of plates comprises a first plate and a second plate,
wherein each of the plurality of plates comprises a first end and a second end, and
the method further comprising affixing the first end of the first plate to the second end of the second plate via a plug.

7. The method of claim 1, wherein the operatively coupling of the plurality of plates comprises welding a first edge of a first plate of the plurality of plates to a second edge of a second plate of the plurality of plates.

8. The method of claim 1, wherein the operatively coupling of the plurality of plates comprises effectuating crystalline bonding of a first edge of a first plate of the plurality of plates to a second edge of a second plate of the plurality of plates.

9. The method of claim 1, wherein the operatively coupling of the plurality of plates comprises arranging each of the plurality of plates to form the non-monolithic structure via 3D printing.

10. The method of claim 1, wherein each of the plurality of plates comprises an extruded corrugated ribbon.

11. (canceled)

12. An assembly comprising:
a housing;
a non-monolithic substrate for a catalyst, the non-monolithic substrate comprising a plurality of plates disposed within the housing, the plurality of plates defining a catalytically active volume of the non-monolithic substrate, wherein a contour of each of the plurality of plates is the same.

13. The assembly of claim 12, wherein the contour of each of the plurality of plates is a curve shape.

14. The assembly of claim 12, wherein the contour of each of the plurality of plates is a v-shape.

15. The assembly of claim 12, wherein the contour of each of the plurality of plates is a multiple-curved s-shape.

16. The assembly of claim 12, wherein the plurality of plates nest together to form a three-dimensional structure.

17. (canceled)

18. The assembly of claim 12, wherein an arrangement of the plurality of plates defines an intake direction for an intake flow to the non-monolithic substrate.

19. The assembly of claim 18, wherein the intake direction is axial.

20. The assembly of claim 18, wherein the intake direction is radial.

21. The assembly of claim 18, wherein the intake direction of the intake flow is multi-axial such that the intake direction includes a first direction along a first segment and a second direction along a second segment, the first direction being different from the second direction.

22. The assembly of claim 12,
wherein the plurality of plates comprises a first plate and a second plate,
wherein the first plate is coated with a first amount of a catalyst coating agent and the second plate is coated with a second targeted amount of the catalyst coating agent, and
wherein the first targeted amount is different from the second targeted amount.
